(19) United States
(12) Patent Application Publication
(10) Pub. No.: US 2015/0143279 A1
(43) Pub. Date: May 21, 2015

(54) METHODS AND SYSTEMS FOR OPTIMIZING USER INTERFACESCREEN SPACE AND CONTENT

(71) Applicant: VMware, Inc., Palo Alto, CA (US)

(72) Inventors: Yochai Uliel, Herzliya (IL); Uri Kochavi, Herzliya (IL); T.N. Ravi Kumar, Karnataka (IN); Urit Piankevich, Herzliya (IL); Nikhil Dhankani, Karnataka (IN)

(73) Assignee: VMware, Inc., Palo Alto, CA (US)

(21) Appl. No.: 14/083,910

(22) Filed: Nov. 19, 2013

(51) Int. Cl. G06F 3/0483; G06F 3/0487; G06F 3/0484

(52) U.S. Cl. CPC G06F 3/0483; G06F 3/04842; G06F 3/0487
USPC 715/777

(57) ABSTRACT

The current disclosure is directed to a graphical user interface (“GUIs”) that displays an optimized arrangement of hierarchical content using an expandable grid. Each item of the content may represent textual information or a numerical value. The expandable grid provides an overview of top-level content by displaying rows on contextually related content in a single list. The rows of top-level content enable a viewer to compare the top-level content of nearby rows in parallel and each content item in a row can be expanded in a tab viewing area which provides a display for a more detail presentation of information regarding the top-level content item using tables, graphs, charts and text.

### TECHNICAL FIELD

The present disclosure is directed to layout and space management of user interfaces, and, in particular, to computational methods and systems that optimize user interface screen space and content.

### BACKGROUND

Since the early 1970's, graphical user interface (“GUI”) technology has advanced to enabled computer users simpler and increasingly more intuitive ways of interacting with a computer, applications, and view content using icons, windows, pop-ups, and a pointing device, such as a mouse-controlled pointer. Content is any textual information or data that may be displayed or visually represented or illustrated on a screen or monitor for viewing. In addition to the visually convenient way of displaying content to a computer user, GUIs have also made it easier to transfer content from one application to another because a typical GUI includes standard formats for representing text and graphics. Because these formats are well-defined, different programs that run under a common GUI can share content. As a result, it is possible to copy and transfer content created by one program into a document created by another program. For example, a GUI enables a graph created by a spreadsheet program to be transferred into a document created by a word processor.

Although GUI technology has provided a way for users to interact with a computer, applications, and content, the manner in which content that represents large amounts of hierarchically related data is displayed using GUI technology is typically cumbersome for users. For example, consider a top list of items displayed in a window for a user. An item can be a word, text, or a numerical value. Each item in the top list has a sub-list of related items that is accessed by clicking on the item in the top list. A user looking at the top list of items in the window may want to compare details regarding two or more items in the top list. However, clicking on any item in the top list opens a separate window and clicking on any item in the sub-list opens another window. As a result, the user's screen space becomes filled with numerous windows that the user has to navigate, resize, and arrange the windows in order to compare the information displayed in each window and then has to navigate back to the first window in order to access the top list. Those working in the computer industry and those who use GUIs to display large amounts of hierarchically related data seek computational systems and methods that optimize use of screen space in order to more efficiently display large amounts of hierarchically related data.

### SUMMARY

The current disclosure is directed to systems and methods that provide a graphical user interface (“GUIs”) in which screen space of a display is optimized by arranging and displaying hierarchical content using a grid of expandable GUI features. The content may be composed of numerous content items that are grouped according to common context. The content items within each group are arranged according to a hierarchy from top-level content items to lower-level content items. Each top-level content item may be decomposed into one or more lower levels of content such that each lower level of content provides more detail regarding the content represented by the top-level content item. The expandable grid provides a viewing area on a screen in which the top-level content items that belong to the same group of contextually related content are arranged in the same row. In other words, vertically stacked panels displayed on the screen are created for each group and within each panel a row of GUI features are labeled by the content items in the same group. When a user interacts with a panel, the panel expands to create a viewing area that displays detailed information regarding the context of the content represented by the group. When a user interacts with a GUI feature within a panel, a tab that labels the content is created in the panel and the tab expands into a viewing area that provides detailed information regarding the content item that labels the GUI feature. User interaction with a different GUI feature in the same panel creates a tab viewing area that replaces a previous tab viewing area so that the context of the panel remains intact while the information displayed changes to that of the content item that labels the different GUI feature.

### DESCRIPTION OF THE DRAWINGS

FIG. 1 shows an example of a generalized computer system that executes efficient methods for managing the space and layout of content in user interface and therefore represents a data-processing system.

FIG. 2 shows an example of hierarchically related content content.

FIG. 3 shows an example window used to display the top-level content represented in FIG. 2.

FIG. 4 shows expansion of a tab to create a tab viewing area within the viewing area of the window shown in FIG. 3.

FIG. 5 shows expansion of a tab to create a tab viewing area within the viewing area of the window shown in FIG. 3.

FIG. 6 shows a window with a viewing area in which a top-level list of data-center customers and contextually related content items are arranged in rows.

FIG. 7 shows an example of a tab viewing area created within the viewing area of the window shown in FIG. 6.

FIG. 8 shows an example of a tab viewing area created within the viewing area of the window shown in FIG. 6.

FIG. 9 shows a flow-control diagram of a method for presenting a graphical user interface with expandable tab grids.

FIG. 10 shows a flow diagram for the routine “display customer content” called in block 915 of FIG. 9.

FIG. 11 shows a flow diagram for the routine “display project content” called in block 916 of FIG. 9.

FIG. 12 shows a flow diagram for the routine “display VM content” called in block 917 of FIG. 9.

FIG. 13 shows a flow diagram for the routine “display service content” called in block 918 of FIG. 9.

FIG. 14 show a flow diagram for the routine “display cost content” called in block 919 of FIG. 9.

### DETAILED DESCRIPTION

This disclosure presents computational systems and methods for graphical user interfaces (“GUIs”) with expandable tab grids that enable various operations over a number of independent items of content with a common context to be viewed within the same viewing space. Each item of the content displayed represents textual information or a numerical value. The expandable tab grid allows the context of each item to remain intact within the same viewing space, such as a window, which, in turn, reduces the number of user interactions to a minimum and optimizes the viewing space.

It should be noted at the onset that data related to optimizing content in a UI is not, in any sense, abstract or intangible. Instead, the data is necessarily digitally encoded and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems on electronically or magnetically stored data, with the results of the data processing and data analysis digitally encoded and stored in one or more tangible, physical, data-storage devices and media.

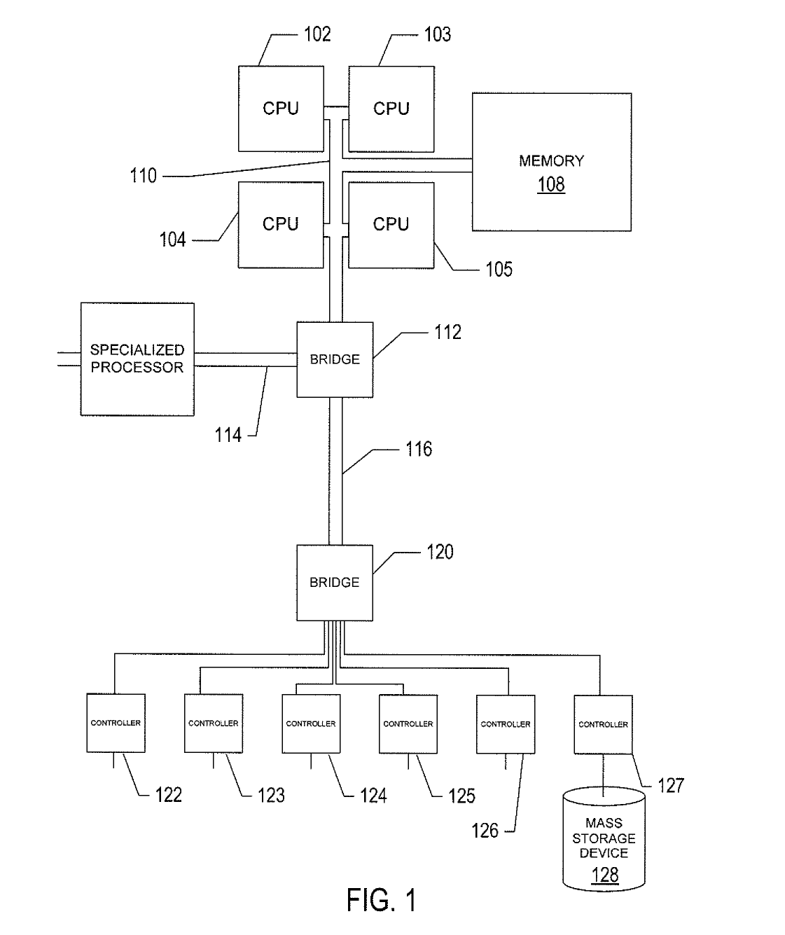

FIG. 1 shows an example of a generalized computer system that executes efficient methods for managing the space and layout of content in user interface and therefore represents a data-processing system. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. The busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of computer-readable media, such as computer-readable medium 128, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 128 is a data-storage device, including electronic memory, optical or magnetic disk drive, USB drive, flash memory and other such data-storage device. The computer-readable medium 128 can be used to store machine-readable instructions that encode the computational methods described below and can be used to store encoded data, during store operations, and from which encoded data can be retrieved, during read operations, by computer systems, data-storage systems, and peripheral devices.

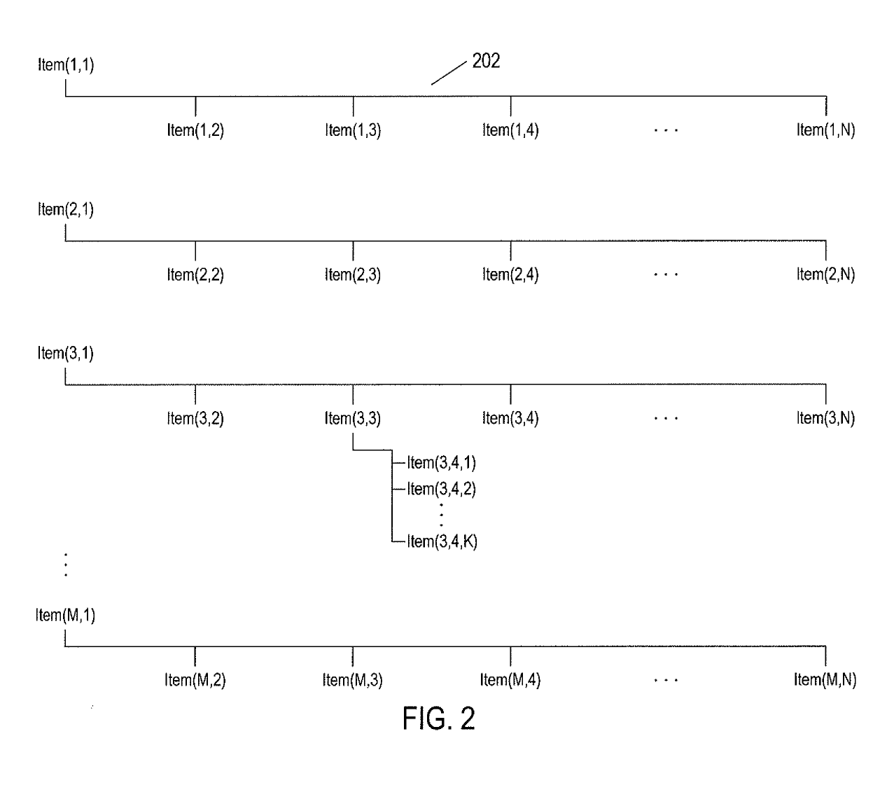

FIG. 2 shows an example of content grouped according to context. Each group of contextually related content is composed of content items that are arranged in a row with each content item denoted by Item(group_index, item_index), where group_index is an integer that ranges from 1 to M in which M is the number of groups, and item_index is an integer that ranges from 1 to N in which N is the number of contextually related items in a group. An item, Item, may represent textual information, such as a name; an Item may represent a numerical value and may include units the indicate the magnitude and what the numerical value represents, or an Item may represent graphical information, such as a bar graph or a line graph. For example, row 202 represents a group of top-level contextually related content items in which Item(1,1) is a label, name, or heading used to identify a group of top-level contextually related content items that are labeled Item(1,2) through Item(1, N). Item(2,1) is a label, name, or heading that identifies an entirely different individual, organization, customer, or entity used to identify a group of top-level contextually related content items labeled Item(2,2) through Item(2, N). Each group of content items is unrelated to and obtained independent of the other groups. Each top-level content item within a group may be decomposed to reveal additional lower-level information about the top-level content item within the context of the group. For example, in FIG. 2, Item(3,3) may be a label that identifies detailed information that is composed of K sub-items identified as Item(3,3,1) through Item(3,3, K), where K is an integer that represents the number of sub-items.

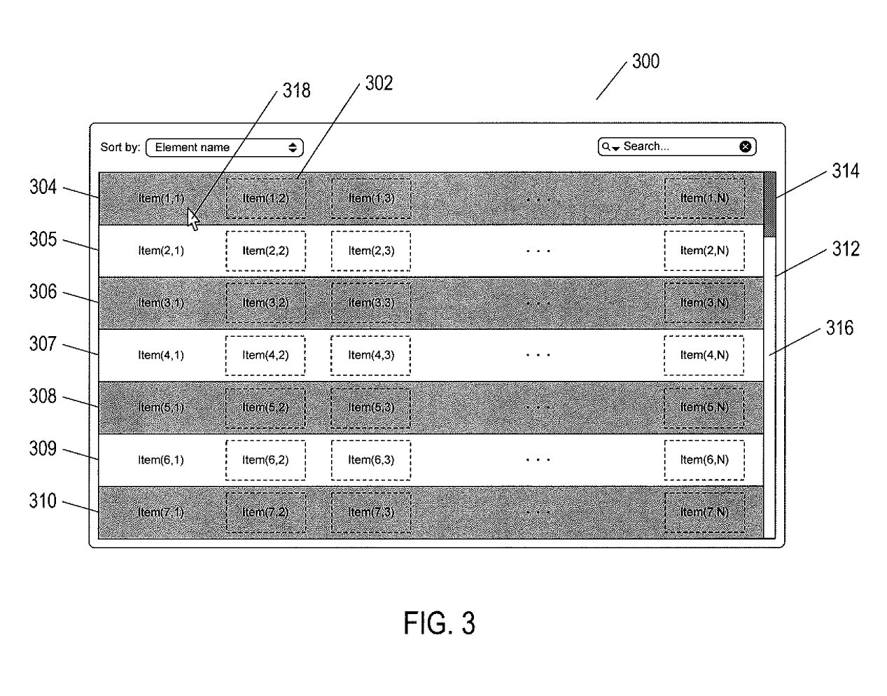

The FIG. 3 shows a window 300 that displays an example grid of expandable GUI features. The expandable grid comprises vertically stacked rectangular-shaped panels 304-310 that each includes a row GUI features represented by dashed-line rectangles, such as rectangle 302. Each row of GUI features corresponds to a one of the groups of contextually related content items shown in FIG. 2. In the example of FIG. 3, the panels 304-310 of GUI features corresponds to the first seven groups of contextually related content items shown in FIG. 2. For example, panel 304 is labeled as Item(1,1) and each of the contextually related content items Item(1,2) through Item(1, N) in FIG. 2 corresponds to one of the GUI features and is used to label the corresponding GUI features. The window 300 includes a vertical scrollbar 312 composed of a bar 314 in a track 316. A user positions the bar 314 somewhere along the track 316 using a pointer or touch screen in order to view up to seven panels of the M rows of top-level content at a time. For example, when a user interacts with a panel i (i.e., 1≦i≦M) outside of the GUI features, such as using a pointer 318 or touching the panel displayed on a touch screen, a tab labeled Item(i, 1) is created and a tab viewing area extending from the tab is created within the window 300. The tab viewing area extending from the tab is created by shifting panels so that the tab viewing area appears within the window 300. The grid of expandable GUI features is called an expandable tab grid.

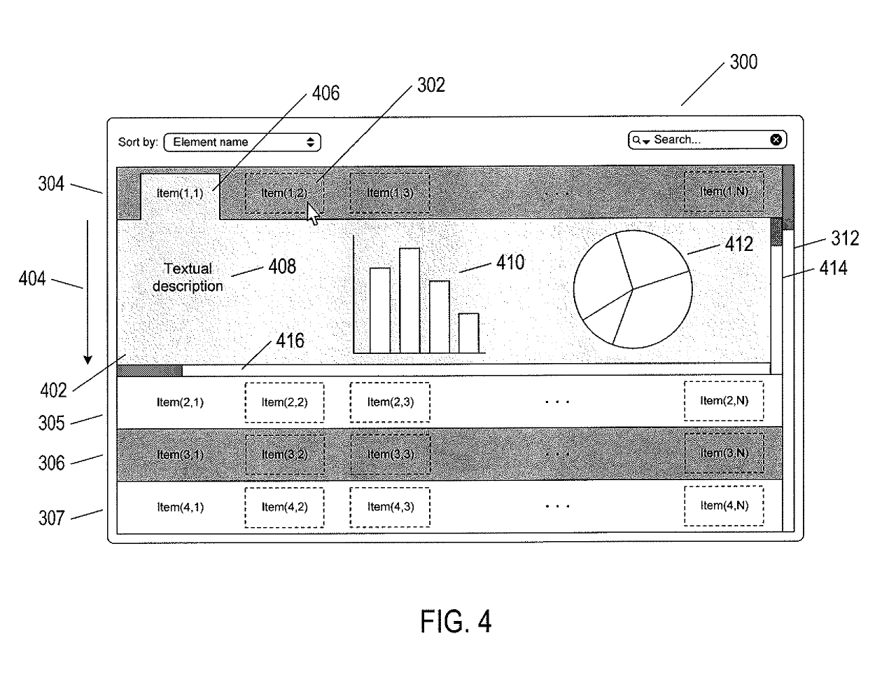

FIG. 4 shows an example of the panel 304 labeled Item(1,1) expanded to create a tab viewing space 402 within the viewing area of the window 300 by shifting the panels 305-307 downward as represented by directional arrow 404. Note that panels 308-310 in FIG. 4 no longer appear in the window 300 but these and other panels may be viewed using the scrollbar 312. The tab viewing area 402 is identified by a tab 406 with the label Item(1,1) and displays a textual description 408, a bar graph 410, and a pie chart 412 that represent general information about the subject matter represented by Item(1,1). In the example of FIG. 4, the tab viewing area 402 may be a window into a larger virtual viewing area that may contain additional information about the subject matter represented by Item(1,1). As a result, the tab viewing area 402 includes a vertical scroll bar 412 and a horizontal scroll bar 416 that enable a user to scroll horizontally and vertically, respectively, over the larger virtual viewing area. The tab viewing area 402 may be collapsed when the user interacts with the tab 406 or replaced by a different tab viewing area when the user interacts with a different GUI feature within the panel 304, such as clicking on, or touching on a touch screen, the GUI feature 302.

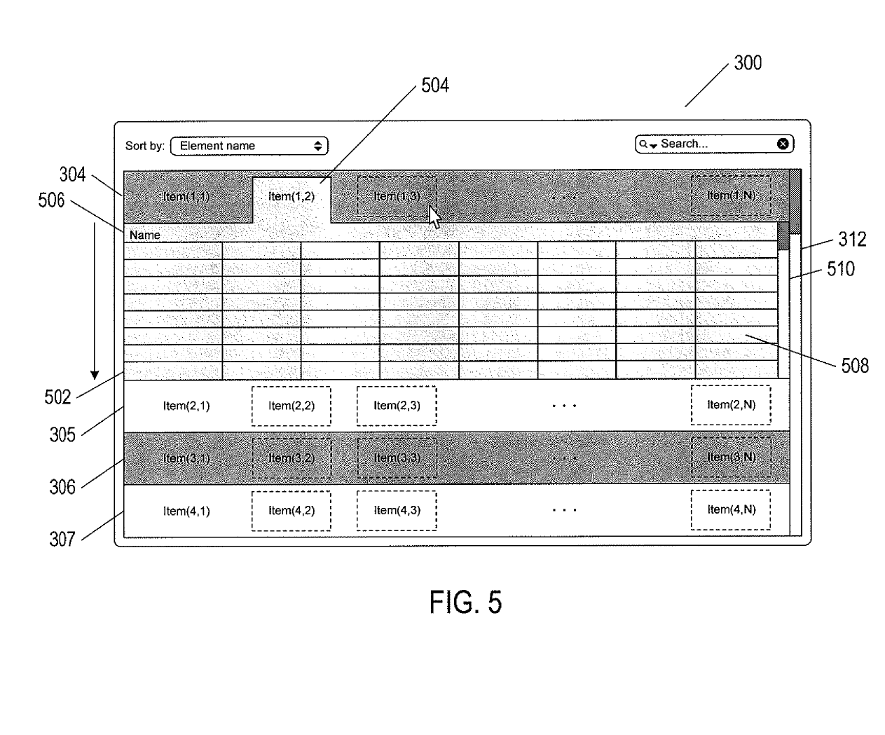

FIG. 5 shows the GUI feature labeled by Item(1,2) expanded to create a tab viewing area 502 within the window 300 to reveal additional information about the Item(1,2). In this example, the tab viewing area 502 includes the tab 504 labeled Item(1,2) and a row 506 of column labels, such as the first column label “Name.” Columns of data are represented by rectangles, such as rectangle 508, that include data associated with each named sub-item. In the example of FIG. 5, the tab viewing area 502 includes a vertical scroll bar 510 that enables a user to scroll through the table of data entries. The tab viewing area 502 may be collapsed when the user interacts with the tab 504 or replaced by a different tab viewing area when the user interacts with a different tab in the panel 304.

An expandable tab grid provides an overview of all top-level content by having all top-level content items displayed in a single list. The panels of top-level content enable a viewer to compare the top-level content of nearby panels in parallel and expansion of a panel allows deeper presentation of various content types such as lists, graphical charts, and text. Replacing content in the tab viewing area by user interaction with the GUI features in the same panel enables display of independent sets of data with the same context.

Note that size of the tab viewing area within a window may be lengthened or reduced when the user interactions with the tab viewing area, such as by dragging an edge of the viewing area inward or outward to set a desired display dimensions for the tab viewing area. The size the tab viewing area may also be changed by the user interacting changing the dimensions of the window 300, such as by dragging an edge of window 300 inward or outward to change the size of the window 300.

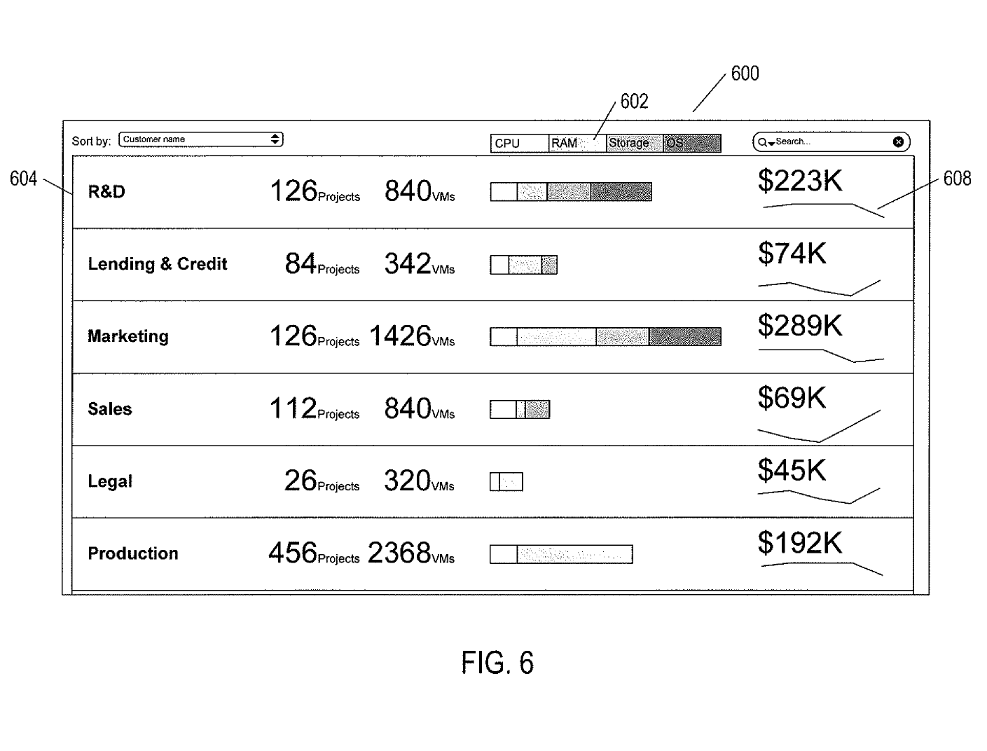

FIGS. 6-8 illustrate an expandable tab grid for a specific example of a group of customers. FIG. 6 shows a window 600 with a viewing area in which a top-level list of data-center customers and contextually related content items associated with each customer. The customers are identified from top to bottom as “R&D,” “Lending & Credit,” “Marketing,” “Sales,” “Legal,” and “Production” and the customer names are used identify each of the six rectangular-shaped panels. Each panel contains a row of contextually related content associated with a customer. In particular, each panel displays the customer's name, total number of projects the customer has run using the data-center resources, total number of virtual machines (“VMs”) used by the customer, a stacked bar chart that represents proportional use of certain computational resources identified in a bar chart legend 602 located in the top boarder of the window 600, and costs with an associated line graph that represents how cost have fluctuated over a period of time. For example, in the first panel 604 labeled as customer “R&D” indicates that “R&D” has 126 projects, used 840 VMs, computational resources are represented by a stacked bar chart 606, current cost are $223,000, and a line graph 608 represents how costs have fluctuated over the past five months. Each panel can be expanded into a tab viewing area when clicked on, and each panel includes a row of GUI features that are labeled by the number of projects, number of VMs, stacked bar charts, and cost. Each GUI feature can be expanded into a tab viewing area when a user interacts with a GUI feature as described above with reference to FIG. 3. For example, when a user touches or clicks on a panel or a GUI feature the panels of other customers are shifted up or down in order to create a tab viewing area within the window 600.

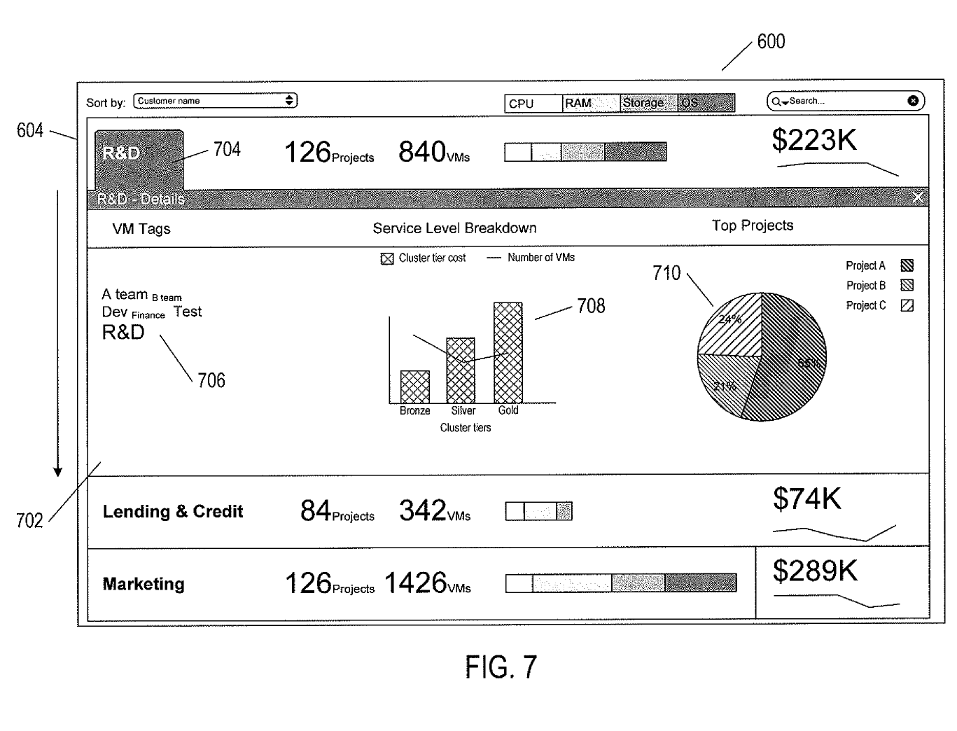

FIG. 7 shows an example of a tab viewing area 702 created within the viewing area of the window 600 as a result of a user interacting with the panel 604 identified by the customer name “R&D.” The tab viewing area 702 is created by shifting the customers below the panel 604 downward. In the example of FIG. 7, the tab viewing area 702 includes a highlighted heading with a tab 704 that identifies the tab viewing area 702 for the customer “R&D.” The tab viewing area 702 displays textual information 706 that further describes the customer “R&D” and includes a bar graph 706 of clusters and VMs used by the customer “R&D” and a pie chart that represents the amount of services used by each of the projects A, B, and C. For example, the user may close the tab viewing area 702 by touching on a touch screen, or clicking on, the tab 704 to return to the top-level content view shown in FIG. 6.

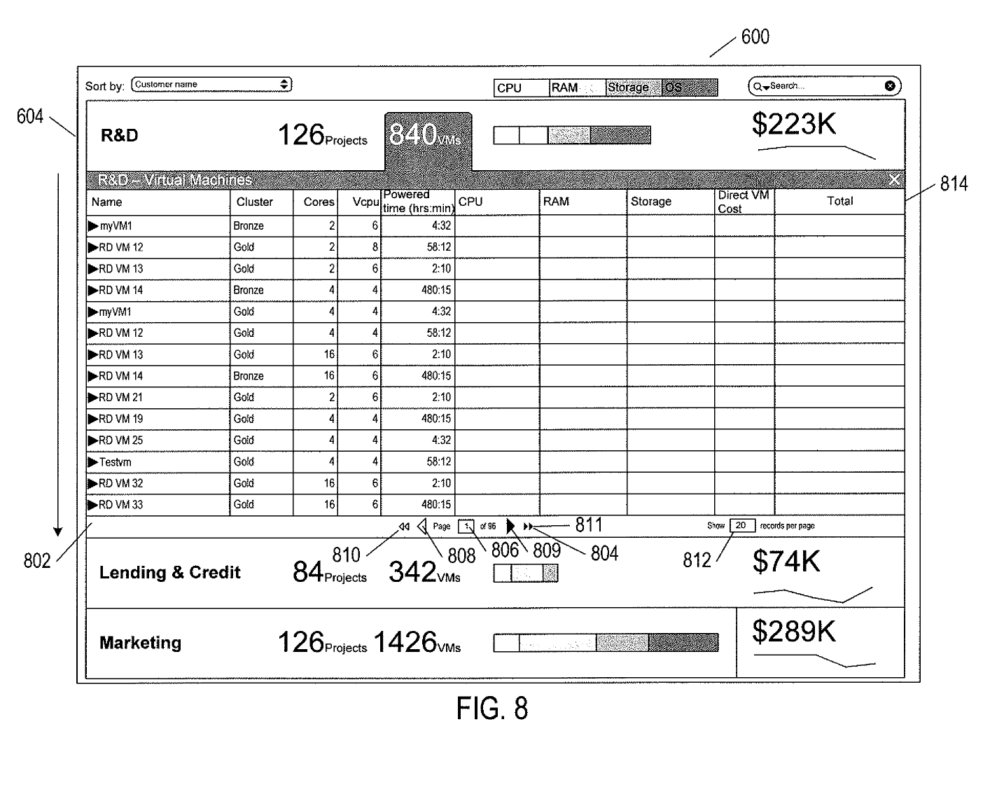

FIG. 8 shows an example of a tab viewing area 802 created within the viewing area of the window 600 as a result of user interaction with the GUI feature labeled as “840 VMs.” Note that the tab viewing area 802 may be created by user interaction with the tab identified by “840 VMs” in the top-level view of the content of the window 600 shown in FIG. 6, by shifting the customers below the panel 604 downward. Alternatively, the tab viewing area 802 may replace the tab viewing area 702 when the user interacts with the GUI feature labeled “840 VMs” in the window 600 shown in FIG. 7. In the example of FIG. 8, the tab viewing area 802 presents detailed information regarding the 840 VMs as a table of records. The number of records displayed in the tab viewing area 802 may be determined by the size of the tab viewing area 802. The scrolling features 804 includes a text box 806 that indicates the page number, line scrolling arrows 808 and 809 that enable a user to scroll up and down through the table record-by-record, and scrolling arrows 810 and 811 that enable a user to scroll through blocks of records. The tab viewing area 802 also includes a text box 812 located along the bottom of the tab viewing area that displays the number of records currently displayed in the tab viewing area 802. The first row 814 of the table is a header that displays the column names. Each record displays a VM name, the name of the cluster or group of computers used, the number of processor cores used, the number of virtual CPUs, and the amount of power consumed in hours and minutes.

In FIGS. 6-8, user interaction with the GUI feature labeled “126projects” creates a tab viewing area within the window 600 that displays detailed information regarding each of the 126 projects. Likewise user interaction with the tab identified by the stacked bar graph creates a tab viewing area with the window 600 that displays detailed information with regard to CPU usage, RAM usage, storage space in use, and other services.

The detailed content displayed in each of the tab viewing areas created when a user interacts with the corresponding GUI features represent content that may be factored into determining the cost. For example, the content displayed in the tab viewing area 802 of FIG. 8 may be a factor in calculating the total cost of $223K. The breakdown of computational services provided by the data center that factor into determining the total cost of $223K can be viewed in a tab viewing area created by a user interacting with the GUI feature labeled by the amount $223K.

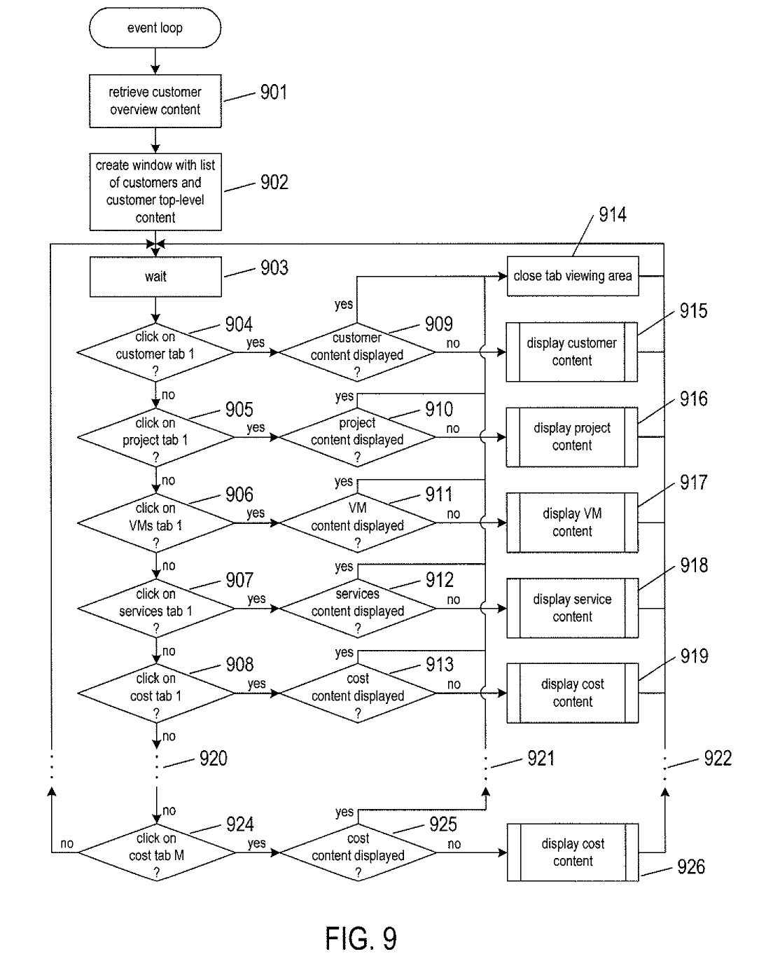

FIGS. 9-14 show flow-control diagrams of a method for presenting a GUI with expandable tab grids that enable content associated with data center customers to be viewed within the same viewing space. For the sake of convenience of illustration, FIGS. 9-14 illustrate the method adapted to a specific example of data center customers described above with reference to FIGS. 6-8, but the method is not intended to be so limited in scope and can be generalized to a provide a GUI with an expandable tab grid for any content with a common context.

In block 901 of FIG. 9, top-level customer content is retrieved from one or more data storage devices. The top-level customer content is composed of the customer's name, total number of projects, total number of VMs, a stacked bar chart that represents use of certain computational resources, and costs, as described above with reference to FIG. 6. In block 902, a window is created to display the top-level content retrieved in block 901 on a monitor, screen, or any type of display. The window includes a viewing area in which the top-level content is displayed in an expandable tab grid as described above with reference to FIGS. 3 and 6. Content items that are contextually related are displayed in the same panel such that each GUI feature in a panel of the expandable tab grid is assigned to one of the contextually related content items as described above with reference to FIG. 3. Each GUI feature is labeled in order to identify the particular kind of content, as described above with reference to FIGS. 2 and 6. In block 903, the method may include a brief waiting period that allows a user time to view the content displayed in the window before any interaction by the user is allowed. Decision blocks 904-908 represent the operations of a user interacting with the panel 604 and the GUI features in the panel 604 of the top-level content shown in FIG. 6. When the user interacts with any one of the GUI features in the first panel, the tabs labeled customer name, project, VMs, services, or cost, the method proceeds to the corresponding decision block of the decision blocks 909-913. For example, block 904 represents when the user clicks on or touches the first panel, such as clicking on the panel labeled customer “R&D” as described above with reference to FIG. 6. As a result, the method proceeds to decision block 909. In decision block 909, if a tab viewing area has already been created for the customer in the first panel, then the method proceeds to block 914 in which case the tab viewing area is closed and the panels are shifted to fill in the tab viewing area, because the user is interacting with the customer tab for a second time in order to close the already created tab viewing area as described above with reference to FIG. 7. Otherwise, if the tab viewing area for the customer has not been created, the method proceeds to block 915 in which a routine “display customer content” is called to display content of the customer in the tab viewing area as described above with reference to FIG. 7. Blocks 915-919 each represents a different routine that is called in response to the user selecting to display additional information regarding the customer, projects, VMs, services, and cost, respectively. In particular, block 916 is a routine “display project content” called to display project content associated with the customer; block 917 is a routine “display VM content” called to display VM content associated with the customer; block 918 is a routine “display service content” called to display service content associated with the customer; and block 919 is a routine “display cost content” called to display cost content associated with the customer. For the sake of brevity, ellipses 920-922 represents blocks that perform the same operations as described for blocks 904-919 but for panels 2 through M of the top-level content displayed in the expandable tab grid, such as the panels 2 through M of the expandable tab grid shown in FIG. 2. Blocks 924-926 represent the operations for the cost content item in the Mth panel of the expandable tab grid.

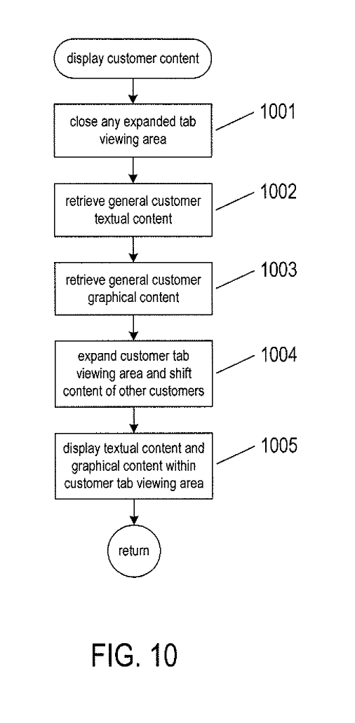

FIG. 10 shows a flow diagram for the routine “display customer content” called in block 915 of FIG. 9. In block 1001, the expanded tab viewing area associated with any other content item is closed. In block 1002, general customer textual content is retrieved from the one or more data-storage devices. In block 1003, general customer graphical content is retrieved from the one or more data storage devices. In block 1004, a customer tab viewing area is expanded from the customer label GUI feature selected by the user and the content in other panels is shifted in order to create space within the window for the customer tab viewing area. In block 1005, the textual content and graphical content regarding the customer is displayed in the customer tab viewing area.

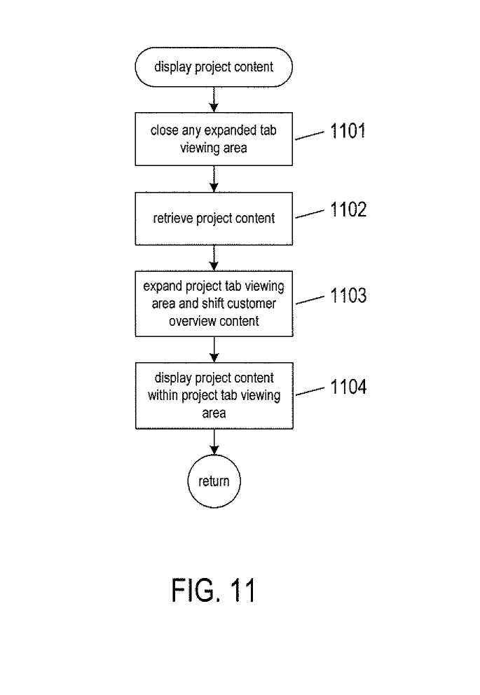

FIG. 11 shows a flow diagram for the routine “display project content” called in block 916 of FIG. 9. In block 1101, the expanded tab viewing area associated with any other content item is closed. In block 1102, content regarding the projects are retrieved from the one or more data storage devices. In block 1103, a project tab viewing area is expanded from the project labeled GUI feature selected by the user and the content in other panels is shifted in order to create space within the window for the project tab viewing area. In block 1104, the project content is displayed in the project tab viewing area. The project content may be displayed in a table or graph depending on the project content to be displayed.

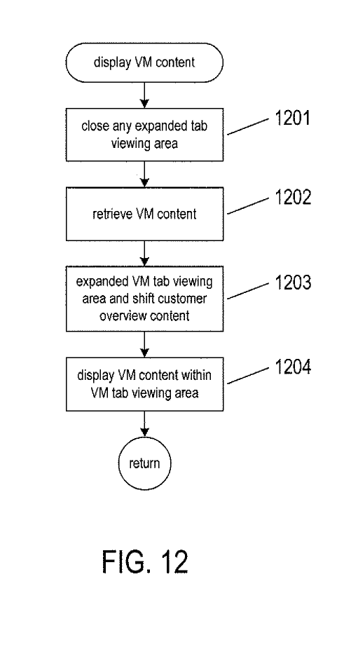

FIG. 12 shows a flow diagram for the routine “display VM content” called in block 917 of FIG. 9. In block 1201, the expanded tab viewing area associated with any other content item is closed. In block 1202, content regarding the VMs are retrieved from the one or more data storage devices. In block 1203, a VM tab viewing area is expanded from the VM GUI feature selected by the user and the content in other panels is shifted in order to create space within the window for the project tab viewing area. In block 1204, the VM content is displayed in the VM tab viewing area. The VM content may be displayed in a table as described above with reference to FIG. 8.

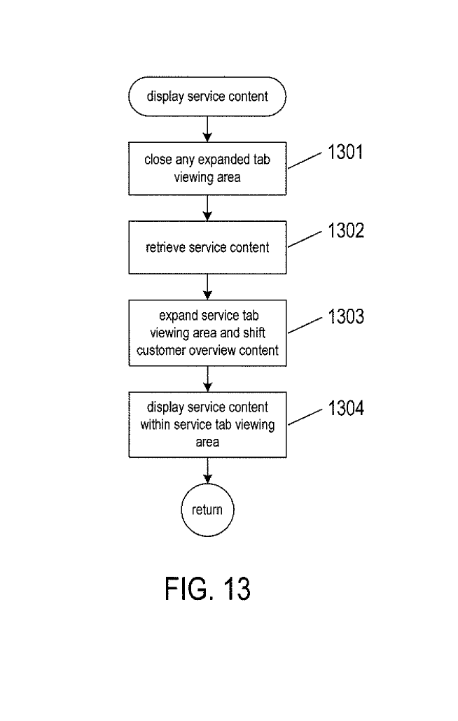

FIG. 13 shows a flow diagram for the routine “display service content” called in block 918 of FIG. 9. In block 1301, the expanded tab viewing area associated with any other content item is closed. In block 1302, content regarding the computational services are retrieved from the one or more data storage devices. In block 1303, a services tab viewing area is expanded from the services GUI feature selected by the user and the content in other panels is shifted in order to create space within the window for the services tab viewing area. In block 1304, the services content is displayed in the services tab viewing area. The services content may be displayed in a table or graphically.

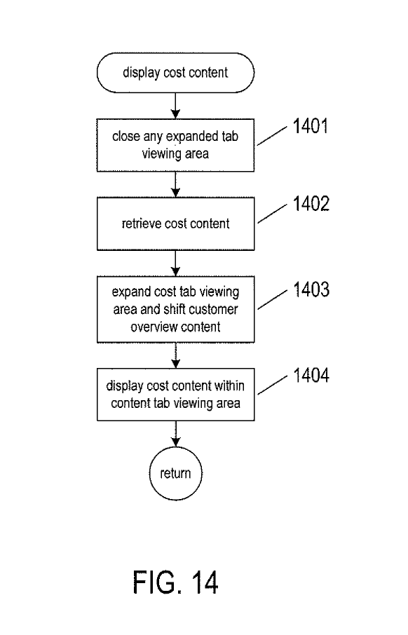

FIG. 14 show a flow diagram for the routine “display cost content” called in block 919 of FIG. 9. In block 1401, the expanded tab viewing area associated with any other content item is closed. In block 1402, content regarding the cost data center computational services are retrieved from the one or more data storage devices. In block 1403, a cost tab viewing area is expanded from the cost GUI feature selected by the user and the content in other panels is shifted in order to create space within the window for the services tab viewing area. In block 1404, the cost content is displayed in the cost tab viewing area. The cost content may be displayed in a table or graphically.

Although the above disclosure has been described in terms of particular embodiments, it is not intended that the disclosure be limited to these embodiments. Modifications within the spirit of the disclosure will be apparent to those skilled in the art. For example, any of a variety of different implementations of displaying content can be obtained by varying any of many different design and development parameters, including programming language, underlying operating system, modular organization, control structures, data structures, and other such design and development parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system for displaying hierarchically related content using a graphical user interface, the system comprising:
one or more processors;
one or more data-storage devices; and
a routine stored in the data-storage devices that when executed using the one or more processors
receives one or more groups of hierarchically related content from the one or more data-storage devices, each group composed of contextually related top-level content and each top-level content item represents lower-level content;
displays a window with panels on a screen and each panel includes a row of graphical user interface features, each feature in a panel corresponds to a top-level content item of one or the groups;
expand a tab viewing area from a panel within the window and displaying information about the group that corresponds to the panel within the tab viewing area, when a user interacts with the panel; and
expand a tab viewing area from a feature within a panel and displaying lower-level content represented by top-level content that corresponds to the feature within the tab viewing area, when a user interacts with the feature.

2. The system of claim 1 further comprises when the user interacts with the panel one or more other panels are shifted to create the tab viewing area.

3. The system of claim 1 further comprise when the user interacts with the feature one or more panels other are shifted to create the tab viewing area.

4. The system of claim 1, wherein each panel is marked with a label that identifies the corresponding group.

5. The system of claim 1, wherein each feature is marked with a label of a top-level content item.

6. The system of claim 1, wherein the screen in a touch screen and the user interacts with a panel or feature by touching the screen.

7. The system of claim 1, wherein the user interacts with the panel or the feature by placing a pointer on the panel or feature and clicking on a pointer controller.

8. A method stored in one or more data-storage devices and executed using one or more processors that displays hierarchically related content using a graphical user interface, the method comprising:
receiving one or more groups of hierarchically related content from one or more data-storage devices, each group composed of contextually related top-level content and each top-level content item represents lower-level content;
displaying a window with panels on a screen and each panel includes a row of graphical user interface features, each feature in a panel corresponds to a top-level content item of one or the groups;
expanding a tab viewing area from a panel within the window and displaying information about the group that corresponds to the panel within the tab viewing area, when a user interacts with the panel; and
expanding a tab viewing area from a feature within a panel and displaying lower-level content represented by top-level content that corresponds to the feature within the tab viewing area, when a user interacts with the feature.

9. The method of claim 8 further comprises when the user interacts with the panel, shifting one or more other panels within the within the window to create the tab viewing area expanded from the panel.

10. The method of claim 8 further comprise when the user interacts with the feature, shifting one or more other panels within the window to create the tab viewing area expanded from the panel.

11. The method of claim 8, wherein each panel is marked with a label that identifies the corresponding group.

12. The method of claim 8, wherein each feature is marked with a label of a top-level content item.

13. The method of claim 8, wherein the screen in a touch screen and the user interacts with a panel or feature by touching the screen.

14. The method of claim 8, wherein the user interacts with the panel or the feature by placing a pointer on the panel or feature and clicking on a pointer controller.

15. A computer-readable medium encoded with machine-readable instructions that implement a method carried out by one or more processors of a computer system to perform the operations of
receiving one or more groups of hierarchically related content from one or more data-storage devices, each group composed of contextually related top-level content and each top-level content item represents lower-level content;
displaying a window with panels on a screen and each panel includes a row of graphical user interface features, each feature in a panel corresponds to a top-level content item of one or the groups;
expanding a tab viewing area from a panel within the window and displaying information about the group that corresponds to the panel within the tab viewing area, when a user interacts with the panel; and
expanding a tab viewing area from a feature within a panel and displaying lower-level content represented by top-level content that corresponds to the feature within the tab viewing area, when a user interacts with the feature.

16. The medium of claim 15 further comprises when the user interacts with the panel, shifting one or more other panels within the within the window to create the tab viewing area expanded from the panel.

17. The medium of claim 15 further comprise when the user interacts with the feature, shifting one or more other panels within the window to create the tab viewing area expanded from the panel.

18. The medium of claim 15, wherein each panel is marked with a label that identifies the corresponding group.

19. The medium of claim 15, wherein each feature is marked with a label of a top-level content item.

20. The medium of claim 15, wherein the screen in a touch screen and the user interacts with a panel or feature by touching the screen.

21. The medium of claim 15, wherein the user interacts with the panel or the feature by placing a pointer on the panel or feature and clicking on a pointer controller.
